(19) United States
(12) Patent Application Publication
(10) Pub. No.: US 2025/0180526 A1
(43) Pub. Date: Jun. 5, 2025

(54) DEEP LEARNING APPROACH FOR AUTOMATED GAS CHROMATOGRAPHY PEAK DETECTION TO ACCOUNT FOR CO-ELUTION

(71) Applicant: REGENTS OF THE UNIVERSITY OF MICHIGAN, Ann Arbor, MI (US)

(72) Inventors: Kevin R. Ward, Superior Township, MI (US); Sardar Ansari, Ypsilanti, MI (US); Loc Cao, Ann Arbor, MI (US); Ruchi Sharma, Ann Arbor, MI (US); Xudong Fan, Saline, MI (US); Wenzhe Zang, Ann Arbor, MI (US)

(21) Appl. No.: 18/964,135

(22) Filed: Nov. 29, 2024

Related U.S. Application Data
(60) Provisional application No. 63/604,323, filed on Nov. 30, 2023.

(51) Int. Cl. G01N 30/86; B01D 53/02; G01N 30/02

(52) U.S. Cl. CPC G01N 30/8631; B01D 53/025; G01N 30/8693; B01D 2257/708; G01N 2030/025

(57) ABSTRACT

Techniques for identifying gas chromatography peaks are disclosed herein. An example method includes receiving chromatographic data of a user that includes data representing at least one volatile organic compound (VOC). The example method further includes analyzing the chromatographic data using a trained peak identification model to output a set of peak identification probabilities. The trained peak identification model is trained using a plurality of training chromatographic data to output a plurality of training sets of peak identification probabilities. The example method further includes generating a set of identified peaks within the chromatographic data by applying a post-processing algorithm to the set of peak identification probabilities and causing the set of identified peaks to be displayed to the user.

### CROSS-REFERENCE TO RELATED APPLICATIONS

This application claims priority to U.S. Provisional Application No. 63/604,323, entitled “Deep Learning Approach for Automated Gas Chromatography Peak Detection to Account for Co-elution.” filed Nov. 30, 2023, and is related to U.S. patent application Ser. No. 18/782,334, entitled “Systems and Methods for Automated Gas Chromatography Peak Alignment.” filed July 24. 2024. the contents of each of which are incorporated herein by reference.

### STATEMENT REGARDING FEDERALLY SPONSORED RESEARCH OR DEVELOPMENT

This invention was made with government support under 4U18TR003812 and 1U01TR004066 awarded by the National Institutes of Health. The government has certain rights in the invention.

### FIELD OF TECHNOLOGY

The present disclosure relates generally to techniques for gas chromatography and, more particularly, to systems and methods for automated gas chromatography peak detection leveraging a deep learning approach using optimization.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

As an inexpensive and non-invasive diagnostic tool, breath analysis has gained traction in the medical research community. The volatile organic compounds (VOCs) in exhaled breath carry information about the body's metabolism, and the change in their composition can signal abnormal physiological conditions or disease. Despite the improvements in breath collection devices that make gas chromatography (GC)-the process of separating a gas mixture into its components-more efficient, the current state of breath analysis is not scalable with multiple steps, potentially leading to inconsistent and non-reproducible results.

### SUMMARY

According to an aspect of the present disclosure, a method for identifying gas chromatography peaks is disclosed herein. The method may comprise: receiving, at one or more processors, chromatographic data of a user that includes data representing at least one volatile organic compound (VOC); analyzing, by the one or more processors, the chromatographic data using a trained peak identification model to output a set of peak identification probabilities, wherein the trained peak identification model is trained using a plurality of training chromatographic data to output a plurality of training sets of peak identification probabilities; generating, by the one or more processors, a set of identified peaks within the chromatographic data by applying a post-processing algorithm to the set of peak identification probabilities; and causing, by the one or more processors, the set of identified peaks to be displayed to the user.

In a variation of this aspect, at least one peak in the set of identified peaks is a co-eluted peak that appears as part of another peak.

In another variation of this aspect, the method may further comprise generating, by the one or more processors executing a simulation algorithm, a set of simulated chromatograms based on a set of reference chromatograms, and wherein the plurality of training chromatographic data is the set of simulated chromatograms.

In yet another variation of this aspect, the simulation algorithm may comprise one or more of: (i) a Gaussian function, (ii), a modified Gaussian function, or (iii) an exponentially modified Gaussian function to generate the set of simulated chromatograms.

In still another variation of this aspect, the chromatographic data may be a one-dimensional (1D) chromatogram.

In another variation of this aspect, the method may further comprise normalizing, by the one or more processors, the chromatographic data to a common value by dividing the chromatographic data by an area under the 1D chromatogram.

In yet another variation of this aspect, the trained peak identification model may be a deep learning model including one or more of: (i) a convolutional neural network (CNN), (ii) a recurrent neural network (NN), (iii) a long short-term memory network, (iv) a gated recurrent unit (GRU), or (v) a transformer network.

In still another variation of this aspect, applying the post-processing algorithm may further comprise analyzing, by the one or more processors, each peak in a derivative of the chromatographic data to determine whether a magnitude of any peak in the derivative exceeds a threshold value; responsive to determining that the magnitude of a respective peak in the derivative does not exceed the threshold value, reducing, by the one or more processors, the magnitude of the respective peak in the derivative to zero; and generating, by the one or more processors, the set of identified peaks without identifying the respective peak in the derivative.

In another variation of this aspect, the method may further comprise smoothing, by the one or more processors, the set of identified peaks using a Gaussian-weighted moving average.

In yet another variation of this aspect, the method may further comprise the chromatographic data comprises data from a vapor space that includes at least one of: (i) exhaled breath, (ii) a wound, (iii) a skin surface, (iv) a sweat droplet, (v) an open cavity, (vi) a closed cavity, or (vii) a urinary catheter bag.

In still another variation of this aspect, the method further comprises outputting, by the one or more processors, lists of matched diseases, which may be or include disease diagnosis, prognosis, severity, tracking, and/or any other suitable metric or values associated with disease/condition evaluation.

In another aspect of the present disclosure, a system for identifying gas chromatography peaks is disclosed. The system may comprise: a memory storing a set of computer-readable instructions; and one or more processors interfacing with the memory, and configured to execute the set of computer-readable instructions to cause the one or more processors to: receive chromatographic data of a user that includes data representing at least one volatile organic compound (VOC), analyze the chromatographic data using a trained peak identification model to output a set of peak identification probabilities, wherein the trained peak identification model is trained using a plurality of training chromatographic data to output a plurality of training sets of peak identification probabilities, generate a set of identified peaks within the chromatographic data by applying a post-processing algorithm to the set of peak identification probabilities, and cause the set of identified peaks to be displayed to the user.

In a variation of this aspect, at least one peak in the set of identified peaks is a co-eluted peak that appears as part of another peak.

In a variation of this aspect, the instructions, when executed, may further cause the one or more processors to: generate, by executing a simulation algorithm, a set of simulated chromatograms based on a set of reference chromatograms, and wherein the plurality of training chromatographic data is the set of simulated chromatograms.

In another variation of this aspect, the simulation algorithm comprises one or more of: (i) a Gaussian function, (ii) a modified Gaussian function, or (iii) an exponentially modified Gaussian function to generate the set of simulated chromatograms.

In yet another variation of this aspect, the chromatographic data is a one-dimensional (1D) chromatogram.

In still another variation of this aspect, the instructions, when executed, may further cause the one or more processors to: normalize the chromatographic data to a common value by dividing the chromatographic data by an area under the 1D chromatogram.

In yet another variation of this aspect, the trained peak identification model is a deep learning model including one or more of: (i) a convolutional neural network (CNN), (ii) a recurrent neural network (NN), (iii) a long short-term memory network. (iv) a gated recurrent unit (GRU), or (v) a transformer network.

In still another variation of this aspect, the instructions, when executed, may further cause the one or more processors to apply the post-processing algorithm by: analyzing each peak in a derivative of the chromatographic data to determine whether a magnitude of any peak in the derivative exceeds a threshold value; responsive to determining that the magnitude of a respective peak in the derivative does not exceed the threshold value, reducing the magnitude of the respective peak in the derivative to zero; and generating the set of identified peaks without identifying the respective peak in the derivative.

In another variation of this aspect, the instructions, when executed, may further cause the one or more processors to smooth the set of identified peaks using a Gaussian-weighted moving average.

In yet another aspect of the present disclosure, a non-transitory computer-readable storage medium having stored thereon a set of instructions, executable by at least one processor, for identifying gas chromatography peaks is disclosed herein. The instructions may comprise: instructions for receiving chromatographic data of a user that includes data representing at least one volatile organic compound (VOC); instructions for analyzing the chromatographic data using a trained peak identification model to output a set of peak identification probabilities, wherein the trained peak identification model is trained using a plurality of training chromatographic data to output a plurality of training sets of peak identification probabilities; instructions for generating a set of identified peaks within the chromatographic data by applying a post-processing algorithm to the set of peak identification probabilities; and instructions for causing the set of identified peaks to be displayed to the user.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates an example environment for identifying co-eluted gas chromatography peaks, in accordance with various aspects disclosed herein.

FIG. 2 illustrates an example system for identifying gas chromatography peaks including components of the example environment of FIG. 1, and in accordance with various aspects disclosed herein.

FIG. 3 illustrates an example data workflow for identifying gas chromatography peaks, as utilized by the example system of FIG. 2, and in accordance with various aspects disclosed herein.

FIG. 4 illustrates an example workflow associated with generating a simulated chromatographic signal, in accordance with various aspects disclosed herein.

FIG. 5 illustrates an example convolutional neural network (CNN) model showing example hyperparameters, in accordance with various aspects disclosed herein.

FIG. 6 depicts example plots showing the peak matching mechanism for non-coeluted and coeluted peaks respectively, in accordance with various aspects disclosed herein.

FIG. 7 depicts example performance plots of the peak identification models as compared to other models, in accordance with various aspects disclosed herein.

FIG. 8 depicts an example disease and trajectory monitoring sequence, in accordance with various aspects disclosed herein.

FIG. 9 illustrates an example method for identifying gas chromatography peaks, in accordance with various aspects disclosed herein, in accordance with various aspects disclosed herein.

FIG. 10 depicts an example graphical user interface diagram that illustrates co-eluted peak identification, in accordance with various aspects disclosed herein.

### DETAILED DESCRIPTION

As previously mentioned, conventional techniques associated with separating a gas mixture into its components as part of a GC analysis is not scalable with multiple steps, and frequently suffers from inconsistent and non-reproducible results. For example, chromatographic peak detection, defined as the identification of the local apex in the chromatogram, is one of the first steps in a GC analysis pipeline. Errors in peak detection can propagate throughout the pipeline, resulting in erroneous analysis. Peak detection aims to locate the peaks that correspond to a VOC in a chromatogram. This step may typically include attempting to identify and separate peaks that appear close to each other but are difficult to separate, referred to as co-eluted peaks.

Conventional techniques generally struggle to perform such peak identification/detection, particularly for co-eluted peaks, as such conventional techniques are often inconsistent and thereby provide unreliable results/outputs. As an example, a proposed method for such peak detection/identification is derivative-based. However, derivative-based approaches are often sensitive to noise, which is frequently reduced using certain signal smoothing techniques that require user-dependent thresholds to limit the number of false positive peaks and are thus themselves inconsistent and/or otherwise arbitrarily defined in a manner that yields inconsistent results.

Other conventional techniques may leverage machine learning models, but they similarly fail to provide reliable outputs. For example, one conventional technique includes a 1D convolutional model using a normalized chromatogram as the input to provide three outputs: peak probability. location, and area. This conventional model may be trained on simulated chromatograms, and this simulation may generally assume that the number of peaks per chromatogram and the peak location are randomly distributed, which fails to account for the peak location dependency present in breath data. Moreover, such conventional models are typically tested using gas mixtures that include significantly fewer (e.g., 16-43) VOCs than the greater than 100 VOCs that usually appear in human breath. These conventional models frequently demonstrate a lower quality performance (e.g., accurately identifying peaks, much less, co-eluted peaks) on gas mixtures with a higher number (e.g., 34-43) of VOCs, indicating that such conventional techniques may be even less accurate on more complex GC signals, such as those measured from human breath. Additionally, the VOCs present in the gas mixtures used to test such conventional techniques generally included a more uniform concentration (e.g., randomly drawn from a uniform distribution) than is commonly present in breath data, which typically includes a relatively small number of VOCs with large amplitudes and many VOCs with relatively smaller amplitudes. Thus, even these conventional techniques attempting to leverage machine learning models generally fail to reliably identify VOC peaks within complex GC signals (e.g., representing human breath).

Moreover, validating conventional GC peak detection algorithms is generally challenging due to the difficulty associated with obtaining accurate and complete peak location annotations when co-eluted peaks are present. Inaccurate and inconsistent annotations may hamper efforts for training and validation of peak detection algorithms. This is especially important in the analysis of more complex chromatograms such as breath data that include many co-eluted peaks. Drift time and signal noise further complicate accurate annotation of the co-eluted peaks which may escape the scrutiny of experienced operators and/or algorithms.

By contrast, the techniques of the present disclosure overcome these challenges faced by conventional techniques to leverage natural distributions of peaks that appear in breath data without utilizing assumptions that typically lead to inconsistencies. More specifically, the present disclosure utilizes a peak identification model/algorithm trained on simulated breath data that is capable of identifying co-eluted peaks within complex GC signals.

For example, unlike may typical models that may be trained on simulated chromatograms with randomly distributed peak numbers and locations, the present techniques utilize simulated breath data that more accurately reflects the natural distribution of peaks found in human breath. This simulated chromatogram data generates a set of simulated chromatograms that may be based a relatively small subset of manually annotated breath data, leading to more complex and representative chromatograms without the need to manually annotate vast sets of chromatogram data. The models/algorithms employed as part of the present techniques may generalize over specific training tasks without operator intervention, leading to more consistent and reliable peak annotations. Thus, these approaches of the present techniques ensure that the models are better prepared to handle the complexity and variability inherent in breath analysis, leading to more accurate peak identification.

Moreover, the peak alignment model of the present techniques is configured to analyze signals that more closely represent human breath samples (e.g., contain significantly more peaks/VOCs) than are typically present in the data analyzed using many common techniques. As mentioned, many typical models are only configured to analyze gas mixtures with a limited number of VOCs (e.g., 16-43) and demonstrate substantially decreased performance (e.g., accuracy) when faced with more complex mixtures (e.g., greater than 43 VOCs present in a gas sample). These issues are further amplified in the case of co-eluted peaks, which are generally more difficult to identify within GC samples, and which are also typically more difficult to identify as the number of peaks/VOCs present within a GC sample increase. The present techniques are configured to handle such greater complexity typically associated with human breath (e.g., over 100 VOCs with varying concentrations) by training the peak alignment model on data that more closely mimics the complexity and concentration variability of VOCs in human breath, resulting in improved performance even in the presence of highly complex GC signals. Accordingly, the peak alignment model of the present techniques achieves significantly higher accuracy when identifying co-eluted peaks than conventional techniques, at least because such conventional techniques are simply incapable of handling and/or otherwise inadequately configured to analyze GC signals with a number of VOCs similar to that of human breath.

Thus, in accordance with the above, and with the disclosure herein, the present disclosure includes improvements in computer functionality or in improvements to other technologies at least because the disclosure describes that, e.g., a server (e.g., a central server), or otherwise computing device (e.g., a user computing device), is improved where the intelligence or predictive ability of the hosting server or computing device is enhanced by a trained peak identification model and post-processing algorithm. These models/algorithms, executing on the server or user computing device, are able to accurately and efficiently identify peaks (e.g., co-cluted peaks) within chromatographic data representing human breath (e.g., acquired from a user). That is, the present disclosure describes improvements in the functioning of the computer itself or “any other technology or technical field” because a server or user computing device, is enhanced with the trained peak identification model and post-processing algorithm to accurately identify chromatogram peaks with reference chromatogram peaks and consequently identify VOCs that improve a user's ability to diagnose various diseases. This improves over the prior art at least because existing systems lack such evaluative and/or predictive gas chromatography peak identification functionality and are generally unable to accurately analyze chromatographic data to output predictive peak identifications (e.g., such as co-eluted peaks) and/or corresponding VOCs represented in human breath GC signals that improve a user/operator's overall diagnostic efforts related to various diseases.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to simulated chromatographic data, etc.) to output the identified peaks within chromatographic data (e.g., co-eluted peaks) that may indicate VOCs within the chromatographic data that may improve the user/operator's diagnostic efforts related to various diseases.

Still further, the present disclosure includes specific features other than what is well-understood, routine, conventional activity in the field, or adding unconventional steps that demonstrate, in various embodiments, particular useful applications, e.g., analyzing, by one or more processors, the chromatographic data using a trained peak identification model to output a set of peak identification probabilities, wherein the trained peak identification model is trained using a plurality of training chromatographic data to output a plurality of training sets of peak identification probabilities; and/or generating, by the one or more processors, a set of identified peaks within the chromatographic data by applying a post-processing algorithm to the set of peak identification probabilities, among others.

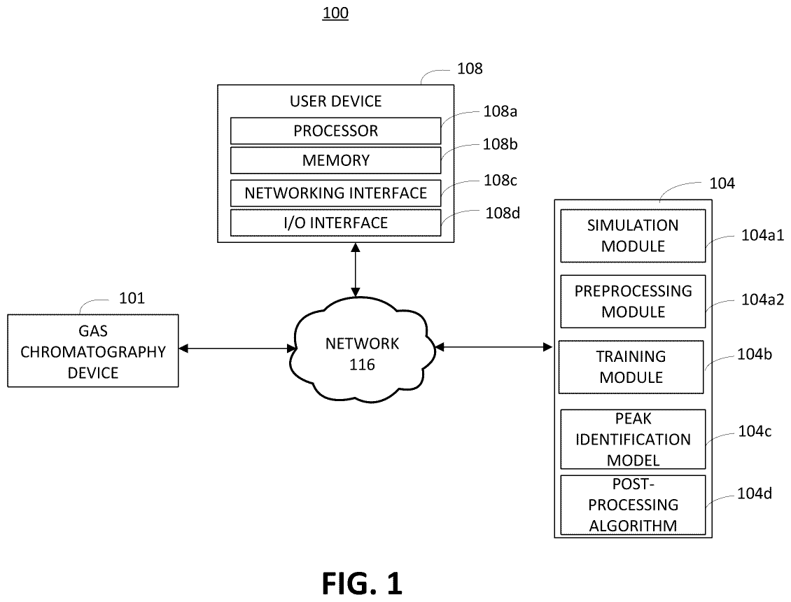

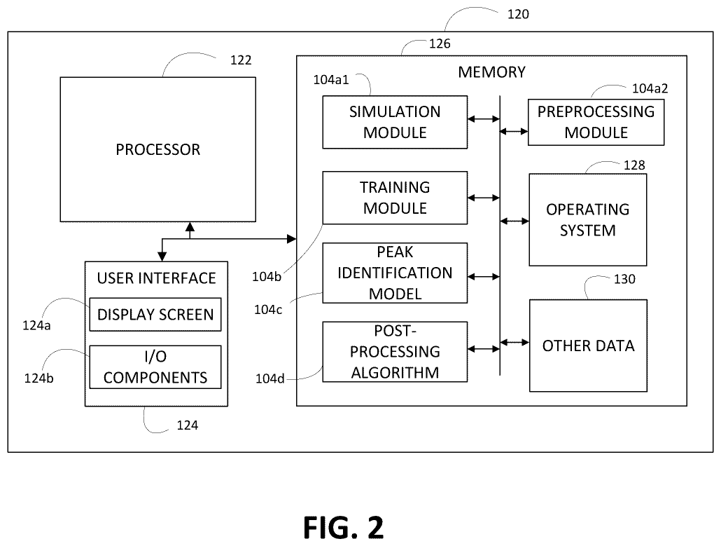

To provide a general understanding of the system(s)/components utilized in the techniques of the present disclosure, FIGS. 1 and 2 illustrate, respectively, a gas chromatography analysis system 104, and an example system 120 containing components of the gas chromatography analysis system 104 that are configured for identifying gas chromatography peaks, particularly co-eluted peaks. Accordingly, FIG. 1 provides a general overview of the gas chromatography analysis system 104 components, and FIG. 2 describes the components and their respective functions in greater detail. Moreover, it should be appreciated that the gas chromatography analysis system 104 may be incorporated as part of the example system 120, and/or the example system 120 may be the gas chromatography analysis system 104.

In any event, FIG. 1 illustrates an example environment 100 for identifying gas chromatography peaks, in accordance with various aspects disclosed herein. It should be appreciated that the example environment 100 and gas chromatography analysis system 104 are merely examples and that alternative or additional embodiments are envisioned.

In reference to FIG. 1, the example environment 100 may be a laboratory, a physician's office, and/or any other suitable location in which a gas chromatography (GC) device 101 may be used. In particular, the example environment 100 includes the gas chromatography (GC) device 101. a gas chromatography analysis system 104, and a user device 108. Broadly, the GC device 101 may receive breaths from a user (e.g., a user may exhale into the GC device 101), the GC device 101 may output chromatographic data to the gas chromatography analysis system 104 across the network 116. and the gas chromatography analysis system 104 may output set of identified peaks (e.g., including co-eluted peaks), VOC pairs, chromatographic data, and/or any other suitable information to the user device 108. The user device 108 may, for example, display the data output from the gas chromatography analysis system 104 for viewing by a user, such as the user that exhaled into the GC device 101. In certain embodiments, the gas chromatography analysis system 104 and the user device 108 may be integrated into a single device or system, such as a workstation in a physician's office. As referenced herein “chromatographic data” may be or include data representative of and/or otherwise extracted from any human and/or otherwise generated vapor space, such as from exhaled breath, wounds, skin, sweat, open/closed cavities (e.g., intestines/stomach, etc.), urinary catheter bags, and/or any other suitable space or combinations thereof. Further, “training data” or “training chromatographic data” may be or include simulated chromatographic data (e.g., as generated by the simulation module 104a1), non-simulated chromatographic data, sets of peak identification probabilities, and/or any other suitable data described herein or combinations thereof.

Generally speaking, the GC device 101 may be any device that is configured to perform the separation and detection of VOCs within a gas sample. The GC device 101 may perform these actions in any suitable number of dimensions (e.g., 1D, 2D, 3D) but for ease of discussion, the GC device 101 may be referenced herein as a one-dimensional (1D) GC device 101. 1D GC generally involves sample (e.g., user breath(s)) and carrier gas injection into the GC device 101 column (not shown), after which, the sample and carrier gas naturally separate as they move towards the column exit. When the sample and/or carrier gas reach the column exit, the gases are detected by a detector (not shown) along with a timestamp representative of the retention time of the gas within the column. The detection and timestamp signals (collectively referenced herein as “chromatographic data”) from the detector may be transmitted to the gas chromatography analysis system 104 for further analysis, and the resulting chromatogram may represent the separation of the various compounds contained in the sample along with the relative abundance of each compound.

For example, the GC device 101 may transmit the chromatographic data to the gas chromatography analysis system 104, where the gas chromatography analysis system 104 may apply/utilize the simulation module 104a1, the preprocessing module 104a2, the training module 104b, the peak identification model 104c, and/or the post-processing algorithm 104d to the chromatographic data. The gas chromatography analysis system 104 may input the chromatographic data into the peak identification model 104c, and the model 104c may output a set of peak identification probabilities that generally represent a likelihood that a particular peak present within chromatographic data from a user corresponds to a reference peak within a reference chromatogram that is associated with a known VOC. To illustrate, the peak identification model 104c may receive chromatographic data of a user that includes 100 distinct peaks, and may output a set of peak identification probabilities that includes a respective peak identification probability for each of the 100 peaks. Further, each peak within the chromatographic data may have multiple peak identification probabilities corresponding to respective likelihoods that the peak corresponds to various peaks within a single reference chromatogram and/or multiple different chromatograms.

In any event, when the peak identification model 104c outputs the set of peak identification probabilities, the gas chromatography analysis system 104 may continue to process the set of peak identification probabilities by executing the post-processing algorithm 104d. The post-processing algorithm 104d may be or include instructions that align the identified peaks with reference peaks associated with known VOCs and/or otherwise optimize the peak identification predicted by the peak identification model 104c. In particular, the post-processing algorithm 104d may be an optimization algorithm (e.g., greedy optimization algorithm, discrete optimization techniques, etc.) that reduces the rate of false positives identified by the peak identification model 104c through the application of several conditional parameters. For example, the post-processing algorithm 104d may cause the gas chromatography analysis system 104 to determine whether a chronology of the chromatographic data corresponds to a predetermined chronology of the set of reference VOCs, whether any peaks from the chromatographic data are orphan peaks, and/or any other suitable criteria or set of criteria.

In certain embodiments, executing the post-processing algorithm 104d may include analyzing each peak in a derivative of the chromatographic data to determine whether a magnitude of any peak in the derivative exceeds a threshold value. Executing the post-processing algorithm 104d may further include determining that the magnitude of a respective peak in the derivative does not exceed the threshold value and reducing the magnitude of the respective peak in the derivative to zero. The threshold value may generally indicate whether a respective peak is or should be identified as a peak potentially representing a VOC and may serve to identify co-eluted peaks that are otherwise difficult to detect within the chromatographic data. Further, executing the post-processing algorithm 104d may include generating the set of identified peaks without identifying the respective peak in the derivative. Namely, because the derivative value of the respective peak fails to satisfy (e.g., meet or exceed) the threshold value, the algorithm 104d may include determining that the peak does not represent a non-co-eluted or a co-eluted peak within the chromatographic data, such that the peak likely does not represent a VOC of interest, and may be ignored.

Moreover, the gas chromatography analysis system 104 may include a simulation module 104a1, a preprocessing module 104a2, and a training module 104b that may generally be configured to collectively train the peak identification model 104c. The simulation module 104al may receive input data (e.g., reference chromatograms) and may generate multiple simulated chromatograms based on those reference chromatograms that are used to train the peak identification model 104c. The preprocessing module 104a2 may perform several actions with respect to the input data, the simulated chromatograms, and the chromatographic data input to the peak identification model 104c, such as baseline removal, and/or smoothing. The peak identification model 104c may generally implement and be trained using machine learning (ML) techniques, and the training module 104b may utilize input training data (e.g., sets of simulated and preprocessed chromatograms from the simulation module 104al and preprocessing module 104a2) to train the model 104c to generate the training outputs (e.g., training sets of peak identification probabilities).

In any event, the peak identification probabilities, VOCs, and/or the chromatographic data may be transmitted from the gas chromatography analysis system 104 to the user device 108 for display and/or interaction with a user. The user device 108 may generally be a mobile device, laptop/desktop computer, wearable device, and/or any other suitable computing device that may enable a user to view the data transmitted from the gas chromatography analysis system 104. The user device 108 may include one or more processors 108a, a memory 108b, a networking interface 108c, and an input/output (I/O) interface 108d. The user device 108 may receive the peak identification probabilities, VOCs, and/or chromatographic data from the gas chromatography analysis system 104 via the networking interface 108c and may display the data to the user via a display or other output device that is included as part of the I/O interface 108d. In certain embodiments, the user may interact with the user device 108 to view various aspects of the data received from the gas chromatography analysis system 104, communicate with the gas chromatography analysis system 104, and/or perform other actions (e.g., contacting a physician's office) in response to receiving the user interaction.

To provide a better understanding of the gas chromatography analysis system 104 functionality, FIG. 2 illustrates an example system 120 for identifying gas chromatography peaks including components of the example environment 100 of FIG. 1, and in accordance with various aspects disclosed herein. In FIG. 2, the example system 120 may be an integrated processing device of the gas chromatography analysis system 104 that includes a processor 122, a user interface 124, and a memory 126. The memory 126 may store the simulation module 104a1, the preprocessing module 104a2, the training module 104b, the peak identification model 104c, and the post-processing algorithm 104d, such that the example system 120 may include the components of the gas chromatography analysis system 104 in FIG. 1. The memory 126 may also store an operating system 128 capable of facilitating the functionalities as discussed herein, as well as other data 130.

Generally, the processor 122 may interface with the memory 126 to access/execute the operating system 128, the other data 130, the simulation module 104a1, the preprocessing module 104a2, the training module 104b, the peak identification model 104c, and/or the post-processing algorithm 104d. The other data 130 may include a set of applications configured to facilitate the functionalities as discussed herein, and/or may include other relevant data, such as display formatting data, etc. For example, the processor 122 may access the operating system 128 in order to execute applications included as part of the other data 130, such as a GC device overview application (not shown) configured to facilitate functionalities associated with monitoring and adjusting parameters associated with a GC device (e.g., central GC device 101) to which the example system 120 is communicatively connected, as discussed herein. As another example, the other data 130 may include operational data associated with the GC device (e.g., column temperature, etc.), and/or any other suitable data or combinations thereof. It should be appreciated that one or more other applications are envisioned. Moreover, it should be understood that any processor (e.g., processor 122), user interface (e.g., user interface 124), and/or memory (e.g., memory 126) referenced herein may include one or more processors, one or more user interfaces, and/or one or more memories.

The processor 122 may access the memory 126 to execute the simulation module 104a1. the preprocessing module 104a2, the training module 104b, the peak identification model 104c and/or the post-processing algorithm 104d to automatically analyze chromatographic data received from a GC device, and as a result, generate peak identification probabilities and/or VOC pairings. Thus, for ease of discussion, it should be understood that when referenced herein as the simulation module 104a1, the preprocessing module 104a2, the training module 104b, the peak identification model 104c, and/or the post-processing algorithm 104d performing an action, the processor 122 may access and execute any of the instructions comprising the simulation module 104a1, the preprocessing module 104a2, the training module 104b, the peak identification model 104c, and/or the post-processing algorithm 104d to perform the action.

The example system 120 may further include a user interface 124 configured to present/receive information to/from a user. As shown in FIG. 2, the user interface 124 may include a display screen 124a and I/O components 124b (e.g., ports, capacitive or resistive touch sensitive input panels, keys, buttons, lights, LEDs). According to some aspects, a user may access the example system 120 via the user interface 124 to review outputs from the forecasting engine 106, make various selections, and/or otherwise interact with the example system 120.

In some aspects, the example system 120 may perform the functionalities as discussed herein as part of a “cloud” network or may otherwise communicate with other hardware or software components within the cloud to send, retrieve, or otherwise analyze data. Thus, it should be appreciated that the example system 120 may be in the form of a distributed cluster of computers, servers, machines, or the like. In this implementation, a user may utilize the distributed example system 120 as part of an on-demand cloud computing platform. Accordingly, when the user interfaces with the example system 120 (e.g., by interacting with an input component of the I/O components 124b), the example system 120 may actually interface with one or more of a number of distributed computers, servers, machines, or the like, to facilitate the described functionalities.

In certain aspects, the example system 120 may communicate and interface with an external server and/or external devices (e.g., user device 108) via a network(s) (e.g., network 116). The network(s) used to connect the example system 120 to the external server/device(s) may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). Moreover, the external server/device(s) may include a memory as well as a processor, and the memory may store an operating system capable of facilitating the functionalities as discussed herein as well as the simulation module 104a1, the preprocessing module 104a2, the training module 104b, the peak identification model 104c, and/or the post-processing algorithm 104d.

Additionally, it is to be appreciated that a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) 122 (e.g., working in connection with the operating system 128) to facilitate the functions as described herein. In this regard, the program code may be implemented in any desired language, and may be implemented as machine code, assembly code, byte code, interpretable source code or the like (e.g., via Golang. Python, Scala, C, C++, Java, Actionscript, Objective-C, Javascript, CSS. XML). In some aspects, the computer program product may be part of a cloud network of resources.

In any event, the example system 120 may initially execute the simulation module 104al. the preprocessing module 104a2, and the training module 104b to train the peak identification model 104c, as previously mentioned. The simulation module 104al may receive an initial set of gas chromatograms and may generate a set of simulated gas chromatograms that may be used as training data for the peak identification model 104c. The preprocessing module 104a2 may perform baseline removal and/or smoothing on each of the initial set of gas chromatograms and/or the simulated gas chromatograms to prepare the gas chromatograms to serve as inputs into the peak identification model 104c. The training module 104b may receive the set of preprocessed, simulated gas chromatograms, and may proceed to train the peak identification model 104c to output peak identification probabilities based on input gas chromatograms generated based on chromatographic data from a user.

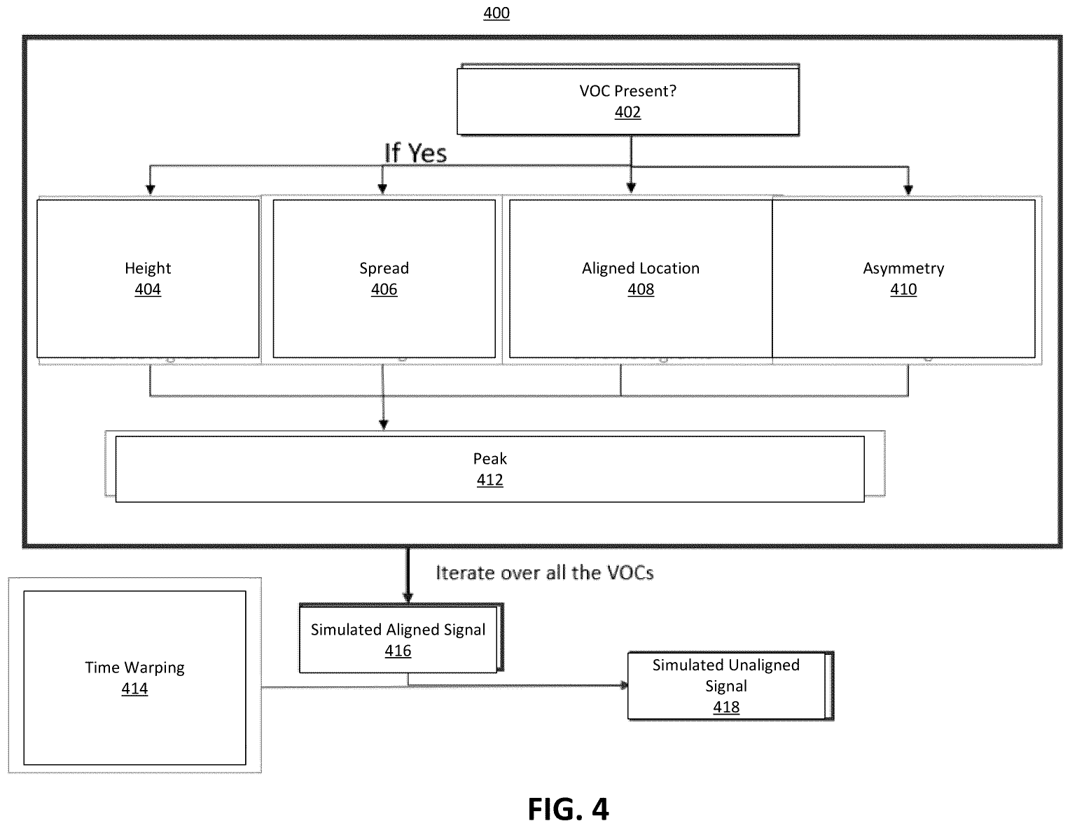

To facilitate the simulation module 104al functions, a relatively small set of gas chromatograms (e.g., less than 100 gas chromatograms) may be annotated and/or otherwise labelled manually to create an initial set of chromatograms. Generally, gas chromatogram labelling is a labor-intensive task, such that large, annotated datasets needed for training machine learning models (e.g., deep learning neural networks) may be difficult to obtain. To overcome these challenges, the simulation module 104al may generate simulated gas chromatograms from the relatively small set of gas chromatograms and may thereby augment the information collected from the annotated gas chromatograms. However, it should be appreciated that larger datasets of gas chromatograms may be used as part of the techniques disclosed herein and may supplement and/or reduce a number of simulated chromatograms required to adequately train the peak identification model 104c. This simulation process performed by the simulation module 104al is further described in reference to FIG. 4.

For example, using the peak information extracted from the labelled set of gas chromatograms, the simulation module 104al may simulate a plurality (e.g., 10,000s) of simulated chromatograms in a stage-wise process. This stage-wise process may include at least two broadly defined stages: simulating the time warping and simulating the gas chromatogram peaks. The first stage may involve dynamic warping quantification and warping combination. The dynamic warping quantification may generally include quantifying the temporal mapping between the retention times of gas chromatogram peaks from their initially unaligned locations to their corresponding aligned locations for each training gas chromatogram. The simulation module 104al may then simulate new warpings by combining (e.g., averaging) any suitable number of warpings randomly sampled from the set of training gas chromatograms. In certain embodiments, the number of warpings to be averaged can be drawn from a random distribution such as Poisson distribution, and/or may utilize any other suitable number of simulated warpings.

The second stage may generally involve the simulation module 104al combining the new warpings simulated in the first stage with individual simulated gas chromatogram peaks. The simulation module 104al may generally determine that a peak is present within a simulated chromatogram using a probability distribution such as Bernoulli (m), where m is a predetermined value, e.g., the prevalence of the peak in the training set of gas chromatograms. If the peak is present, the simulation module 104al may generate the actual aligned and unaligned peaks using a parameterized function such as a Gaussian or an Exponentially modified Gaussian function. The simulation module 104al may also define simulated peak parameters (e.g., peak shape, peak amplitude, peak width, aligned location, etc.) by averaging the same parameters in n training gas chromatograms randomly sampled from the training set of gas chromatograms, where n is drawn from a random distribution such as Poisson. The simulation module 104al may generate the corresponding unaligned locations of the gas chromatogram peaks using the warpings obtained from the first stage.

When the simulation module 104al finishes generating the set of simulated gas chromatograms, the module 104a may transmit the full set of reference gas chromatograms (e.g., initial training gas chromatograms and simulated gas chromatograms) to the preprocessing module 104a2 and/or the training module 104b. The preprocessing module 104a2 may generally perform various actions on and/or with the simulated gas chromatograms, as described herein, such as baseline removal, smoothing, and/or any other suitable action(s) to prepare them for use by the training module 104b. The training module 104b may broadly use the full set of reference gas chromatograms to train the peak identification model 104c to receive a gas chromatogram as input and output peak identification probabilities. These peak identification probabilities may generally indicate a likelihood that a particular portion of a gas chromatogram is a peak or a co-eluted peak (e.g., as included in a reference gas chromatogram). These peak identification probabilities may also directly indicate that the identifier peak (e.g., a co-eluted peak) corresponds to a particular VOC. Of course, it should be appreciated that the simulation module 104a2 may perform the gas chromatogram simulation sequence described above in any suitable number of stages and/or may generate any suitable number of simulated gas chromatograms, and as further described in reference to FIG. 4.

In any event, the preprocessing module 104a2 may receive the simulated gas chromatograms and/or the initial training gas chromatograms and proceed to adjust the gas chromatograms by shifting the gas chromatograms (e.g., simulated gas chromatograms) relative to the training (i.e., reference) gas chromatograms and/or performing other actions or combinations thereof. In certain embodiments, the preprocessing module 104a2 may smooth the gas chromatogram signals, and/or derivatives thereof, to reduce and/or eliminate the effects of noise on the resulting analysis performed by the peak identification model 104c.

As another example, the preprocessing module 104a2 may shift the simulated gas chromatograms such that a centroid (e.g., the mean of the peak locations) of the simulated and the reference gas chromatograms are aligned. This shifting to a common fixed centroid may reduce the overall distance of the unaligned and reference peaks and enable the peak identification model 104c to perform a more efficient search for the correct alignment and peak identification by limiting the size of the search space.

The training module 104b may receive these gas chromatograms (e.g., real/augmented and simulated) from the preprocessing module 104a2 and the simulation module 104al and proceed to train the peak identification model 104c using these gas chromatograms as inputs. More specifically, the training module 104b may be configured to utilize artificial intelligence (AI) and/or machine learning (ML) techniques to train the peak identification model 104c. The training module 104b may generally employ supervised or unsupervised machine learning techniques, which may be followed or used in conjunction with reinforced or reinforcement learning techniques. As noted above, in some embodiments, the gas chromatography analysis system 104 or other computing device may be configured to implement machine learning, such that the gas chromatography analysis system 104 “learns” to analyze. organize. and/or process data through the peak identification model 104c without being explicitly programmed. Thus, the training module 104b may train the peak identification model 104c to automatically analyze chromatographic data from a GC device (e.g., GC device 101), and thereby enable the gas chromatography analysis system 104 to automatically process user chromatographic data without requiring manual intervention.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks (CNN), deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning. Of course, it should be appreciated that the machine learning models and techniques utilized herein may be or include any suitable models or techniques, such as variations CNNs (e.g., residual neural network or attention-based network) and/or recurrent neural networks (RNNs) (e.g., long short-term memory networks, gated recurrent units (GRUs), transformer networks, and/or other networks with/without an attention mechanism).

In one embodiment, the training module 104b may employ supervised learning techniques, which involves identifying patterns in existing data to make predictions about subsequently received data. Specifically. the training module 104b may “train” the peak identification model 104c using training data, which includes example inputs (e.g., reference and/or simulated chromatograms) and associated example outputs (e.g., corresponding peak identification probabilities and/or associated VOCs). Based upon the training data, the training module 104b may cause the peak identification model 104c to generate a predictive function which maps outputs to inputs and may utilize the predictive function to generate machine learning outputs based upon data inputs. The example inputs and example outputs of the training data may include any of the data inputs or machine learning outputs described above. In the example embodiment, a processing element may be trained by providing it with a large sample of data with known characteristics or features.

In another embodiment, the training module 104b may employ unsupervised learning techniques, which involves finding meaningful relationships in unorganized data. Unlike supervised learning, unsupervised learning does not involve user-initiated training based upon example inputs with associated outputs. Rather, in unsupervised learning, the training module 104b may cause the peak identification model 104c to organize unlabeled data according to a relationship determined by at least one machine learning method/algorithm employed by the training module 104b. Unorganized data may include any combination of data inputs and/or machine learning outputs as described above.

In yet another embodiment, the training module 104b may employ reinforcement learning techniques, which involves optimizing outputs based upon feedback from a reward signal. Specifically, the training module 104b may cause the peak identification model 104c to receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Of course, other types of machine learning techniques may also be employed, including deep or combined learning techniques.

After training, the peak identification model 104c and/or other machine learning programs (or information generated by such machine learning programs) may be used to evaluate additional data. Such data may be and/or may be related to chromatographic data and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs (e.g., trained peak identification model 104c) may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the training module 104b may train the peak identification model 104c to output peak identification probabilities, associated VOCs, and/or any other values or combinations thereof using artificial intelligence (e.g., a machine learning model of the peak identification model 104c) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

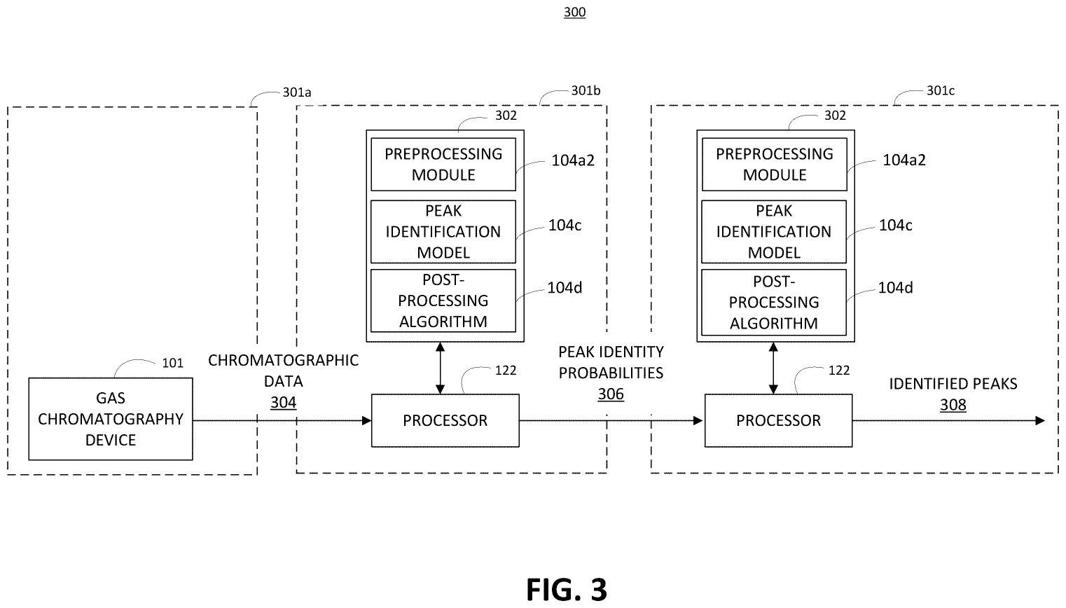

FIG. 3 illustrates an example data workflow 300 for identifying gas chromatography peaks, as utilized by the example system 120 of FIG. 2, and in accordance with various aspects disclosed herein. Broadly, the example data workflow 300 may include three stages: receiving chromatographic data 304 of a user from a GC device 101 (a first stage 301a), analyzing the chromatographic data 304 to determine peak identification probabilities 306 (a second stage 301b), and generating a set of identified peaks 308 between the chromatographic data 304 and the set of reference peaks (a third stage 301c). It should be appreciated that the example data workflow 300 may utilize any suitable components from the example system 120 and/or the example environment 100 of FIG. 1, and is not limited to the components (e.g., processor 122) illustrated in FIG. 3.

As mentioned, the first stage 301a may generally involve receiving chromatographic data 304 of a user from a GC device 101. The GC device 101 may receive a breath sample from the user and may process the breath sample to generate chromatographic data 304, as described herein. Based on the chromatographic data 304, the GC device 101 may generate a gas chromatograph representing the various VOCs present in the breath sample, and as reflected in the chromatographic data 304. The chromatographic data 304 of a user may typically include data representing multiple VOCs, but in certain embodiments, the chromatographic data 304 should represent/include at least one VOC. Accordingly, when the GC device 101 generates the gas chromatograph corresponding to the chromatographic data 304, the GC device 101 may transmit the gas chromatograph to the server (e.g., gas chromatography analysis system 104), where it is analyzed by the processor 122.

The server may receive the chromatographic data 304 (represented as a gas chromatogram) from the GC device 101 and may cause the processor to execute instructions stored in the first location 302 (e.g., memory 126) corresponding to the peak identification model 104c to analyze the chromatographic data 304 in the second stage 301b. More specifically, the processor 122 may execute the peak identification model 104c to analyze the chromatographic data 304 and output a set of peak identification probabilities 306. As previously described, the peak identification model 104c may be trained using a plurality of training chromatographic data to output a plurality of training sets of peak identification probabilities. Further, the set of peak identification probabilities 306 may generally be or include likelihood values corresponding to various candidate peak identifications between peaks in the chromatographic data 304 and peaks in the reference (e.g., simulated) chromatograms.

As described herein, and as part of the chromatographic data 304 analysis process, the peak identification model 104c, the preprocessing module 104a2, and/or the post-processing algorithm 104d may perform actions configured to augment the chromatographic data to identify/annotate co-eluted peaks within the data 304. It should be understood that the model 104c, the module 104a2, and/or the algorithm 104d may perform any and/or all of these actions described herein in reference to the chromatographic data augmentation process during training of the model 104c and/or during active implementation of the model 104c (e.g., after training) to analyze new chromatographic data. Generally speaking, the model 104c, the module 104a2, and/or the algorithm 104d may use the aggregate information present in the chromatogram data 304, such that it may be assumed that a co-eluted peak and/or corresponding VOC is present when the peak appears consistently in the chromatogram signals analyzed by the model 104c, the module 104a2, and/or the algorithm 104d.

As provided below, cₖ(t), cₖ″ (t), and s (t) to denote the raw chromatogram for kth chromatogram, the negative second derivative for kth chromatogram, and the sum over all-cₖ″(t) signals, respectively. Using Fourier series, Cₖ(t), cₖ″(t), and s (t) can be generally written as:

$${c}_{k} ( t ) = {\sum }_{n = 1}^{∞} {a}_{n} {e}^{int} , \qquad ( 1 )$$

$$- {c}_{k}^{″} ( t ) = ( {\sum }_{n = 1}^{∞} {a}_{n} {n}^{2} {e}^{int} ) , \qquad ( 2 )$$

$$s ( t ) = - {Σ}_{k} {c}_{k}^{″} ( t ) , \qquad ( 3 )$$

such that-cₖ″(t) may act as a high pass filter, amplifying the higher frequency components and diminishing the lower frequency components. This increases the separation of the peaks and/or the corresponding VOCs analyzed/determined by the model 104c by narrowing the width of individual peaks.

The model 104c and/or the module 104a2 may be configured to assume that most/many peaks in the chromatogram data 304 generally follow a Gaussian or modified Gaussian pattern, where the peak location may be conserved through even-order derivatives. In addition, the second derivative of both Gaussian and modified Gaussian functions, after correcting for inversion, have a single peak. As a result, the model 104c and/or the module 104a2 may apply the second derivative (e.g., equation (2)) to a signal that is a combination of Gaussian and modified Gaussian functions without introducing additional unwanted peaks into the signal, which may not be true about higher order derivatives or other types of high-pass filters in general.

As the second derivative (e.g., equation (2)) can be affected more severely by noise than the original chromatographic data (e.g., 304) represented by equation (1), the values associated with equation (2) may benefit from smoothing (e.g., via the preprocessing module 104a2) before the peak identification model 104c performs peak detection using the data. The preprocessing module 104a2 may utilize a moving average with a window size of any suitable size (e.g., 7 samples) to achieve an appropriate smoothness to the data associated with equation (2). The model 104c may detect peaks in the smoothed second derivative data (e.g., equation (2)) and match these peaks to the initial peaks detected within the original chromatographic data 304 (e.g., represented by equation (1)). The model 104c and/or the algorithm 104d may then use the matched peaks to align all the second derivative signals of the chromatographic data 304 (e.g., equation (2)) by means of interpolation. By doing so, the model 104c and/or the algorithm 104d may accurately align all peaks to the same approximate location in time that were identified as part of the original chromatographic data 304 as well as any co-eluted peaks within the data 304.

The model 104c and/or the algorithm 104d may utilize summation to aggregate the aligned signals associated with the second derivative (equation (2)). The model 104c and/or the algorithm 104d may then utilize the sum denoted by equation (3), which may be the result of adding the stacked aligned signals of equation (2) together. Generally, the model 104c and/or the algorithm 104d may be configured to assume that co-eluted peaks that consistently appear in a large proportion of the aligned chromatograms will result in a peak of the relation represented by equation (3) and peaks that are due to noise appear in the signals inconsistently and may consequently average out. Therefore, the model 104c and/or the algorithm 104d may utilize an unconstrained derivative-based peak detection to identify the peaks in the relationship represented by equation (3). In certain embodiments, the model 104c and/or the algorithm 104d may further analyze the second derivative signals (equation (2)) in tandem/combination with the signals represented by equation (3) to identify and add other peaks and/or corresponding VOCs that are co-eluted with sufficiently high confidence.

As an example, the initial chromatographic data 304 may include 130 annotated peaks (e.g., as provided manually). Following the actions described herein in reference to the chromatographic data augmentation process, the peak identification model 104c, the preprocessing module 104a2, and/or the post-processing algorithm 104d may determine an additional 59 peaks (with corresponding likelihoods) and/or corresponding VOCs that are co-eluted peaks within the initial chromatographic data 304 but unidentified by the manual annotation. Accordingly, the augmentation process described herein enables the various components described herein (e.g., as part of the environment 100) to accurately augment raw chromatographic data 304 with additional annotations (e.g., peak identifications) for co-eluted peaks (among others) that may have been missed during an initial inspection.

When the processor 122 has successfully executed the peak identification model 104c to determine the set of peak identification probabilities 306, the processor 122 may proceed to execute the post-processing algorithm 104d in the third stage 301c. The post-processing algorithm 104d may include various instructions configured to cause the processor 122 to analyze the peak identification probabilities 306 in tandem with certain criteria (e.g., chronology preservation, no orphan peaks, no prior peak/reference peak assignments) that may optimize the peak identifications, and thereby minimize the rate of false positive and/or otherwise erroneous peak identifications. Accordingly, the processor 122 may execute the post-processing algorithm 104d to generate a set of identified peaks 308 based on the peak identification probabilities 306. The identified VOCs 308 may generally be or include indications of a particular VOC represented by the peak of interest. For example, a first identified VOC may indicate that a first peak of interest included as part of a user's chromatographic data 304 corresponds to the presence of a first VOC within their breath, and a second identified VOC may indicate that a second peak of interest included as part of the user's chromatographic data 304 corresponds to the presence of a second VOC within their breath.

These identified VOCs 308 output by the processor 122 as a result of executing the post-processing algorithm 104d may be displayed to a user in response to their generation. Namely, the processor 122 may cause the identified VOCs 308 to be displayed on a display device (e.g., display screen 124a) for viewing and/or other interpretation by a user. As part of this display, the processor 122 may further accompany the identified VOCs 308 with predetermined and/or otherwise known explanations for what each of the identified VOCs 308 may indicate. For example, the processor 122 may cause a first identified VOC to be displayed to the user, and may further cause the display to indicate that the presence of the first identified VOC in chromatographic data 304 is generally indicative of a user having asthma. In any event, when the processor 122 causes the identified VOCs 308 to be displayed to a user, the processor 122 may wait for further instructions in response to user interactions with the device (e.g., user device 108) on which the identified VOCs 308 are displayed. Moreover, any/all of the identified VOCs 308, gas chromatograms, and/or any other data described herein may be used to train and/or apply a classification or regression algorithm configured to provide diagnoses, prognoses, and/or severity assessments associated with various medical conditions, as discussed herein.

FIG. 4 illustrates an example workflow 400 associated with generating a simulated chromatographic signal. Some/all of the actions described herein may be performed by, for example, the simulation module 104a1 of FIG. 1. The module 104al may normalize the training data (e.g., 28 GCs) to have a total area of one and determine whether a particular VOC is present within the data used to simulate chromatogram signals (block 402). If such a VOC is present, the module 104al may estimate the parameters that are needed for the simulations including peak heights (block 404), weights (block 406), aligned locations (block 408), and asymmetries (block 410). The module 104a1 may combine each of these parameters to generate simulated peaks 412 that are part of the overall simulated chromatograms. The module 104al may iteratively perform this simulation analysis for each identified VOC/peak within the original/training chromatographic data to output a simulated aligned signal 416, where the simulated peaks are aligned with the peaks of the original/training chromatographic data (e.g., that may be annotated with known peaks/VOCs).

The module 104al may determine a simulated time warping (e.g., block 414) based on a linear combination of n ˜ Poisson (1) sampled time warping functions (e.g., mapping from aligned to unaligned peak locations) in the training chromatographic data. The time warping function (block 414) may be a bijective map between the unaligned and aligned locations. The module 104al and/or other suitable component(s) may determine the bijective map by utilizing linear interpolation and execute a stepwise chromatogram simulation using hyperparameters estimated from the original/training chromatographic data and the distribution of the aligned location (e.g., block 408).

Each peak/VOC may appear in the simulated signals with a probability p, and the module 104al may estimate such probabilities using the frequency by which the peak/VOC appears in the original/training chromatographic data. The module 104al may generate the peak shape using a linearly normal distribution centered at the aligned location with height (block 404), standard deviation, and asymmetry (block 410), that may each be equal to a linear combination of n ˜ Poisson (1) randomly sampled peak heights, standard deviations, and asymmetries from instances of that peak/VOC in the training chromatographic data. The module 104al may also fit linearly modified Gaussian curves to smoothed chromatograms to estimate the spread 406 of each detected peak. The module 104al may then apply the simulated time warping function 414 on the simulated aligned signal 416, which may generally represent the sum of all individual Gaussian curves, to generate/determine the simulated unaligned signal 418.

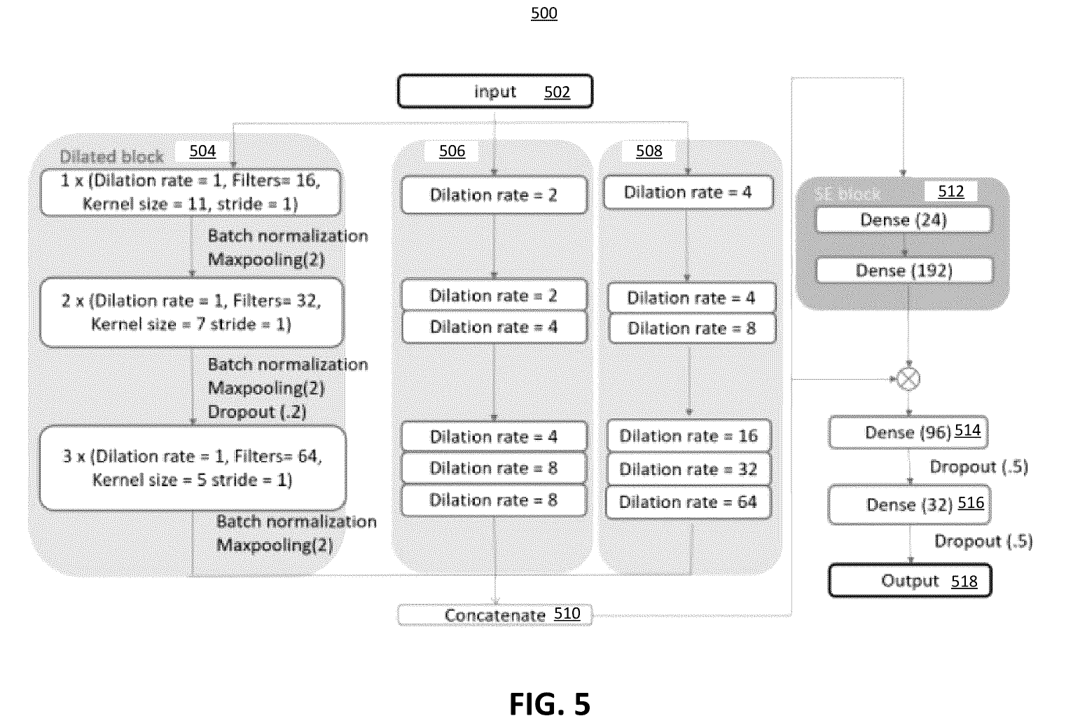

FIG. 5 illustrates an example convolutional neural network (CNN) model 500 showing example hyperparameters, in accordance with various aspects disclosed herein. In certain embodiments, the CNN model 500 may be configured to perform one or more of the actions described herein, for example, in reference to the peak identification model 104c of FIG. 1. The CNN model 500 may generally use a convolutional neural network with parallel dilation blocks followed by squeeze-and-excitation (SE) blocks. Following the input layers 502 are three parallel dilated blocks 504, 506, and 508 with different dilation rates. This dilated CNN model 500 may capture and localize information at different frequencies by introducing “holes” of different size, referenced as “dilation rate”, into the convolutional filters. Different dilation rates enable the CNN model 500 to learn different features in the chromatographic signal.

Each block 504, 506, and 508 may be composed of three stacks of convolutional layers separated by a batch normalization and a max pooling layer, where the number of layers and filters may iteratively increase at every stack. For example, and as illustrated in FIG. 5, the number of layers may increase by one at each stack and the number of filters may double at every stack. The output from the three blocks may then be concatenated (e.g., block 510) before passing through an SE block 512 and dense layers 514, 516 with a sigmoid final layer activation that links the model output 518 to the target output.

Thus, due to the CNN model 500 structure illustrated in FIG. 5, the size of the model output 518 may be equal to an eighth of the input size. To correct for the effects of pooling, the components described herein (e.g., the training module 104b) may upsample the inputs by a factor of, for example, eight (e.g., from 4 Hertz (Hz) to 32 Hz) using linear interpolation. During training, the training module 104b and/or other suitable components described herein may also augment the input data by adding noise with the signal-to-noise ratio drawn from a uniform distribution between 40 decibels (db) and 90 db during training and may later validate such augmentation on simulated signals without adding noise. The output after upsampling may remain at the same frequency as the original signal, such that the target labels become a binary vector of l's at each peak location and 0's everywhere else. Of course, it should be understood that the unaligned signal along with the unaligned peak locations may be used in the training of the CNN model 500.

More specifically, the components described herein (e.g., the training module 104b) may train the CNN model 500 to minimize a binary cross-entropy loss between the model output 518 and the binarized peak locations using an Adam optimizer and/or other suitable optimizer. For example, the Adam optimizer may have an initial learning rate of 0.01 that decreases 10 folds for every 3 epochs in which no improvement on the validation set is observed. In addition, to prevent overfitting, the training module 104b may terminate the CNN model 500 training in the case of no significant improvement in multiple (e.g., five) consecutive epochs and/or if the CNN 500 model has been trained for at least a threshold number of epochs (e.g., 100 epochs). The training module 104b and/or other suitable components described herein may also adjust the output 518 of the CNN model 500 by smoothing the output 518. For example, the training module 104b may utilize a Gaussian-weighted moving average with an optimized window size (e.g., seven samples) to remove minor, unwanted noise in the model output 518.

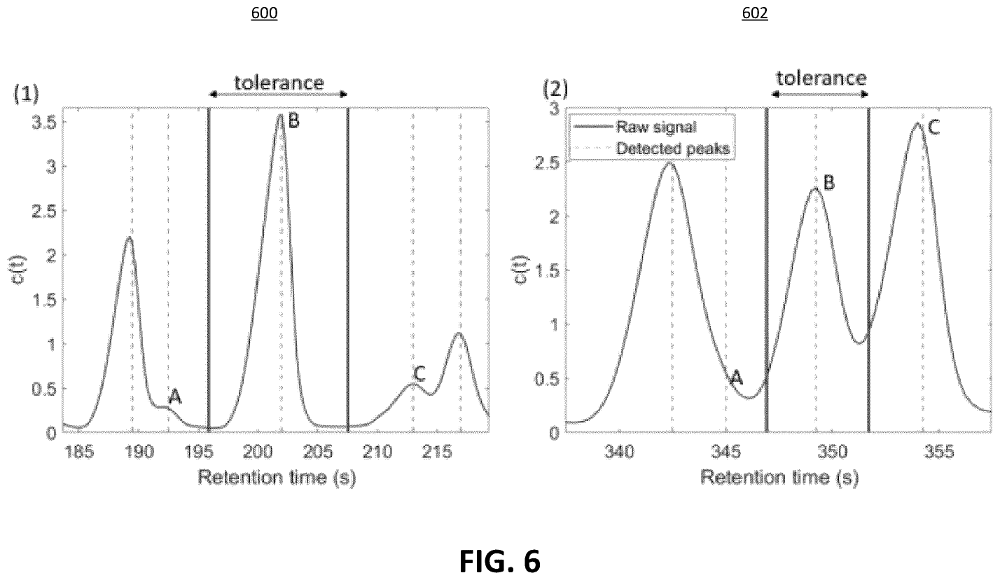

Additionally, or alternatively, the training module 104b may implement a peak matching mechanism to facilitate the comparison between the performance of different algorithms that may be used as part of the peak identification model 104c (e.g., including the CNN model 500). A detected peak and a true peak may be considered correctly matched (e.g., true positives) if the detected peak falls within a known tolerance from the true peak. False positives may be defined as when no matches are found for a detected peak, while false negatives are when no matches are found for a true peak. The training module 104b and/or other suitable components may define the tolerance associated with determining correctly matched peaks may be the half distance between the true peak and its immediate neighboring peaks, as shown in FIG. 6.

Namely, FIG. 6 depicts example plots 600, 602 showing the peak matching mechanism for non-co-eluted and co-eluted peaks, in accordance with various aspects disclosed herein. As illustrated in the example plots 600, 602, the tolerance for peak B may be the sum of half the distance between peak B and the two neighboring peaks (e.g., A and C). Any peak that falls within that tolerance (e.g., between the solid vertical lines surrounding peak B) may be considered a match to peak B. Additionally, peak A may be a co-eluted peak that may be identified through the peak identification processes described herein.

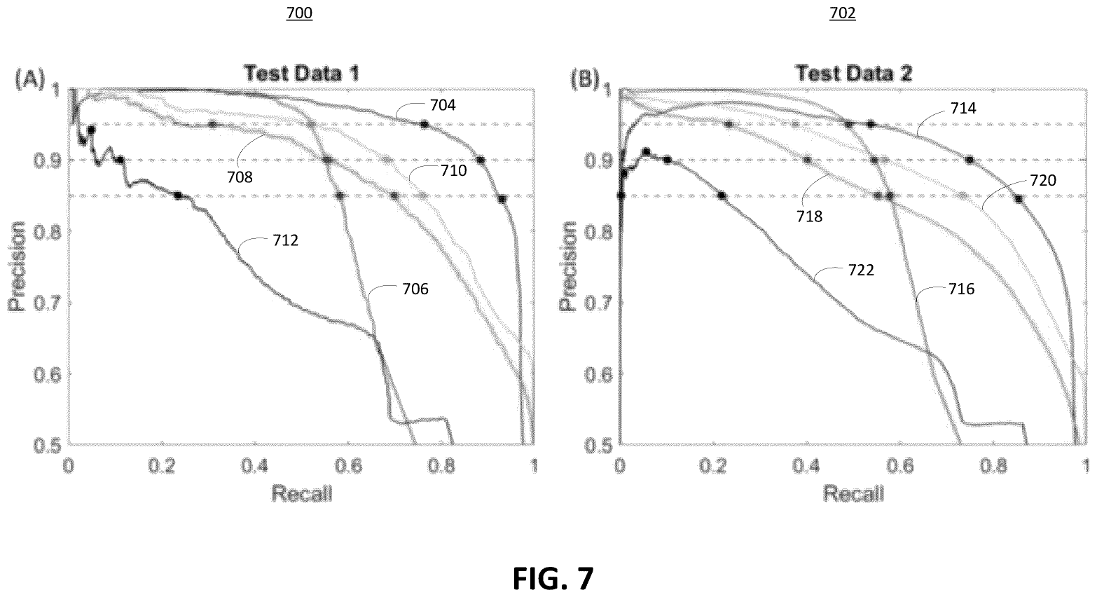

FIG. 7 example performance plots 700, 702 of the peak identification models as compared to other models, in accordance with various aspects disclosed herein. For example, the example performance plots 700, 702 may include a first signal 704 representing the performance of the various models (e.g., CNN model 500, peak identification model 104c) plotted against the performance of four different versions of peak detection algorithms which may not produce outputs with as much recall and/or precision as the outputs provided by the present techniques. In the example performance plots 700, 702, precision (y-axis) may be plotted against recall (x-axis) for all five algorithms using the real test data. The dashed lines may mark different values of precision (e.g., 0.85, 0.9, and 0.95). For example, a second signal 706 may represent outputs resulting from using the raw signal (e.g., equation (1)) while a third signal 708 and a fourth signal 710 may result from using the second derivative signal (e.g., equation (2)) before and after smoothing, respectively.

Based on this data represented in the example performance plots 700, 702, the components described herein may determine the area under the precision-recall curve (AUPRC) for each algorithm. The data represented by a fifth signal 712 may take in a fixed input length of 8192 samples and output the peak probability, corresponding peak location, and peak areas. This test data may be upsampled (e.g., because of the difference in sampling rate), but this processing step may result in more than one probability per real peak location. In other words, instead of having integer peak location, the algorithm represented by the fifth signal 712 may potentially output fractional peak locations after the output is downsampled. To address this problem, the peak locations may be rounded to the nearest integers, and any duplicated peaks resulting from this process may be maintained, which results in significantly duplicated and/or otherwise erroneous data, as represented in the relative lack of precision/recall of the fifth signal 712.

By contrast, the presently disclosed CNN model (e.g., CNN model 500) output (e.g., output 518) is processed, as discussed herein, and an unconstrained derivative-based peak detection may be applied to the model output to identify the peaks and their associated scores to calculate the model performance (e.g., first signal 704). To generate the scores representing the second signal 706. the third signal 708, and the fourth signal 710, an unconstrained peak detection may be performed first and the detected peak prominence in the chromatogram may be used as the score to calculate the AUPRC.

As shown in FIG. 7, with an event rate of 5.48% and an AUPRC of 0.94 (95% CI: 0.93-0.95) on test data 1 (e.g., in example performance plot 700), the CNN model (e.g., first signal 704) may predict significantly better than the algorithms represented by the other signals 706-712 that achieved AUPRCs of 0.66 (95% CI: 0.64-0.68) and 0.75 (95% CI: 0.73-0.77), respectively. Moreover, the CNN model's performance (e.g., first signal 704) surpassed both the performance of the algorithms representing the fourth signal 710 (AUPRC of 0.90, 95% CI: 0.89-0.91) and the third signal 708 (AUPRC of 0.87, 95% CI: 0.86-0.88).

Similar performance trends are observed across different test data (e.g., in test data 2 of the example performance plot 702). Although the absolute performance, measured in AUPRC, decreased slightly for the CNN model (represented by the first signal 714) and the algorithms associated with the third signal 718 and the fourth signal 720 as compared to the example performance plot 700, the CNN model still outperformed the rest of the models with an AUPRC of 0.90 (95% CI: 0.89-0.90). The performance gap between the CNN model and the fourth signal 720 (AUPRC of 0.88, 95% CI: 0.88-0.89) may have shrunk, but the CNN model may have significantly higher sensitivity at fixed PPV values of 0.85, 0.9 and 0.95. The difference between the third signal 718 (AUPRC of 0.84, 95% CI: 0.83-0.84) and the fourth signal 720 may have remained at approximately three percentage points. Moreover, the difference in performance of the algorithms represented by the fifth signal 722 (AUPRC of 0.67, 95% CI: 0.66-0.67) and the second signal 716 (AUPRC of 0.74, 95% CI: 0.73-0.75) between test data 1 and 2 (e.g., example performance plots 700 and 702) may be minimal/negligible. Thus, across both sets of test data, the algorithms/models described herein consistently and significantly outperformed other algorithms/models attempting to perform similar peak/VOC identification tasks.

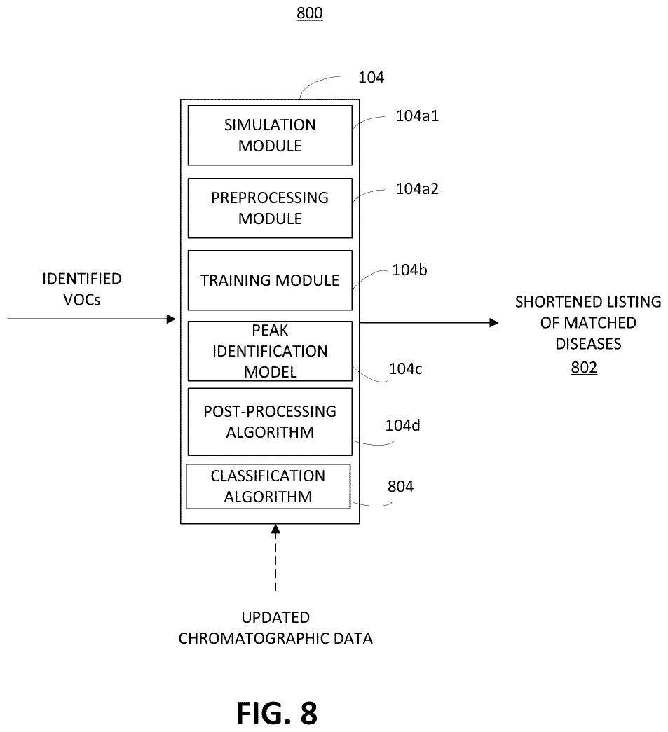

FIG. 8 depicts an example disease and trajectory monitoring sequence 800, in accordance with various aspects disclosed herein. As illustrated in FIG. 8, the gas chromatography analysis system 104 may receive the identified VOCs from a previously analyzed set of chromatographic data (e.g., a user's prior breath sample), may receive a set of updated chromatographic data (e.g., a user's recent breath sample), and may proceed to determine a shortened listing of matched diseases 802. Generally speaking, the shortened listing of matched diseases 802 may be, include, and/or otherwise correspond to (i) one or more diseases that a user is predicted to have based on the analysis performed on the user's identified VOCs and the user's updated chromatographic data. (ii) a prognosis for a particular disease or condition from which the user's identified VOCs and updated chromatographic data may indicate the user may be suffering, (iii) the severity of a disease that the user may be suffering from, and/or may also include any other suitable values or combinations thereof or described herein. Of course, the example disease and trajectory monitoring sequence 800 depicted in FIG. 8 is an example and for the purposes of discussion only. Such monitoring, diagnostics, prognostics, tracking, severity evaluation, and/or other functions described herein may be performed using any of the modules or other components described herein and any of the data described herein.

As an example, the classification/regression algorithm 804 may be a classification model (e.g., leveraging AI or ML) trained to detect various diseases using chromatographic data and/or identified VOCs from such chromatographic data. Namely, the classification algorithm 804 may be trained to output disease diagnoses/prognoses/severity measures/values using training chromatographic data from patients with various diseases along with training sets of such diagnoses/prognoses/severity measures/values. This training process for the classification algorithm 804 may also include various controls, such as using features of the identified VOCs (e.g., measured areas/intensities of the identified VOCs in the chromatogram data) to train the classification algorithm 804. Thus, in this example, the classification model 604 may receive chromatogram data and/or identified VOCs from such chromatogram data, and may proceed to generate the shortened listing of matched diseases 802, which may be or include various predicted disease diagnoses, prognoses, severity values/measures, and/or any other suitable values or combinations thereof.

As another example, a user may provide a first breath sample (or other suitable inputs) to a GC device (e.g., GC device 101) at a first time, and the classification/regression algorithm 804 may analyze that breath sample as described herein to determine the identified VOCs. The user may subsequently provide a second breath sample to the GC device 101 at a second time (different from the first time), and the classification/regression algorithm 804 may receive this second breath sample as the updated chromatographic data. Consequently, the classification/regression algorithm 804 may analyze the identified VOCs from the user's first breath sample in tandem with any identified VOCs in the updated chromatographic data from the user's second breath sample to characterize and quantify the presence of VOCs in the user's breath samples over time. In this manner, the gas chromatography analysis system 104 (e.g., via the classification/regression algorithm 804) may effectively and accurately track the progress, development, and/or severity of any predicted diseases and/or other conditions from which the user may be suffering.

In the prior example, the classification/regression algorithm 804 may interpret the identified VOCs from the user's first breath sample to determine that a first VOC and a second VOC are present in the user's breath at uncommonly high proportions at the first time. As a result, the classification/regression algorithm 804 may determine that the user is suffering from a first condition/disease. At the second time, the classification/regression algorithm 804 may analyze the identified VOCs from the user's second breath sample to determine that the first VOC and the second VOC are significantly less present in the user's breath at the second time. The classification/regression algorithm 804 may then compare this analysis of the updated chromatographic data with the prior analysis of the identified VOCs from the first time to determine that the user's condition/disease may be improving. The classification/regression algorithm 804 may thereby provide users with diagnoses, prognoses, and/or severity values/measures of diseases/conditions through progressively updated analysis of a user's chromatographic data.

As mentioned, it should be appreciated that the classification/regression algorithm 804 may utilize ML and/or any other suitable techniques, as described herein. The classification/regression algorithm 804 may be trained using sets of training identified VOCs, sets of training updated chromatographic data, and sets of matching diseases/conditions. As a result, the classification/regression algorithm 804 may be trained to output lists of matched diseases (e.g., shortened listing of matched diseases 802), which may be or include disease diagnosis, prognosis, severity, tracking, and/or any other suitable metric or values associated with disease/condition evaluation.

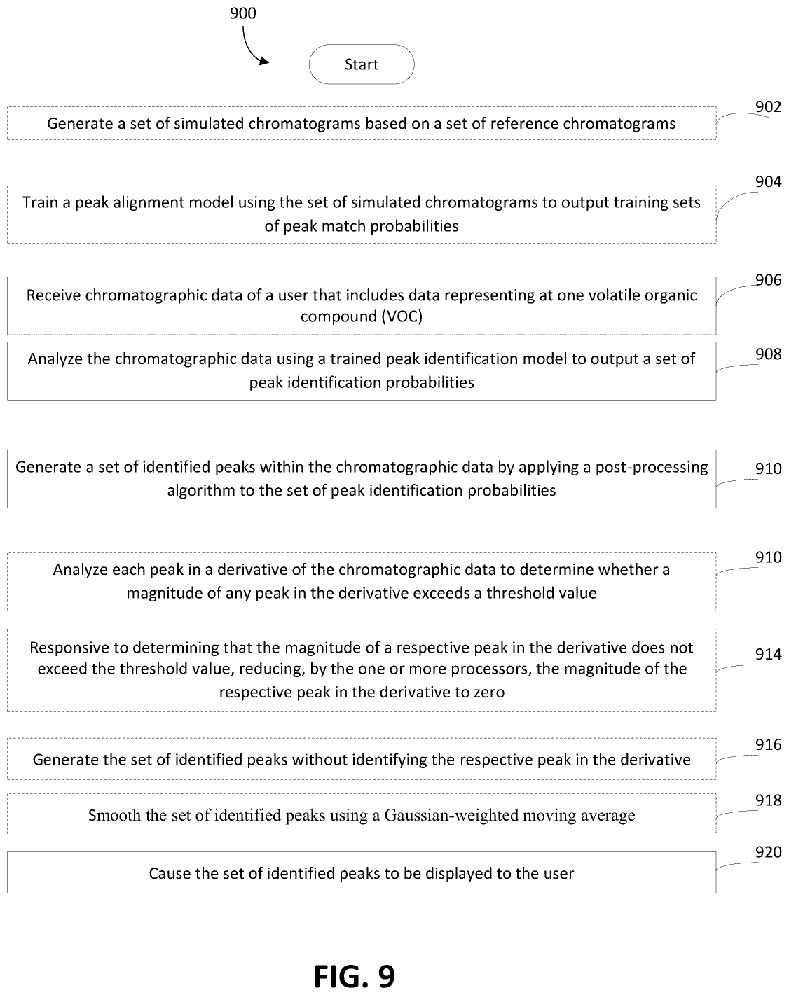

FIG. 9 illustrates an example method 900 for identifying gas chromatography peaks, in accordance with various aspects disclosed herein. For ease of discussion, many of the various actions included in the method 900 may be described herein as performed by or with the use of a processor (e.g., processor 122). However, it is to be appreciated that the various actions included in the method 900 may be performed by, for example, any suitable processing device (e.g., gas chromatography analysis system 104, user device 108, example system 120) executing the simulation module 104a1, the training module 104b, the peak identification model 104c, the post-processing algorithm 104d, and/or other suitable modules/models/applications or combinations thereof.

The example method 900 optionally includes generating a set of simulated chromatograms based on a set of reference chromatograms (block 902). The plurality of training chromatographic data may be the set of simulated chromatograms. The example method 900 may further optionally include training a peak identification model using the set of simulated chromatograms to output training sets of peak identification probabilities (block 904). As a result of this training, the peak identification model may thereafter be configured to receive chromatogram data and/or other suitable data or combinations thereof as inputs, and may output peak identification probabilities, as described herein.

Additionally, or alternatively, the example method 900 may also include the receiving chromatographic data of a user that includes data representing at least one VOC (block 906). In some embodiments, the chromatographic data may be a one-dimensional (1D) chromatogram. The example method 900 may also include analyzing the chromatographic data using a trained peak identification model to output a set of peak identification probabilities (block 908). The trained peak identification model may be trained using a plurality of simulated chromatographic data to output a plurality of training sets of peak identification probabilities. The example method 900 may also include generating a set of identified peaks within the chromatographic data by applying a post-processing algorithm to the set of peak identification probabilities (block 910).

Moreover, in certain embodiments, the peak identification model, post-processing algorithm, and/or other suitable components described herein may be unable to match identified peaks within the chromatographic data to VOCs with a certainty that satisfies a certainty threshold. In these embodiments, to identify when the components described herein fail to map the peaks to VOCs with certainty levels satisfying the certainty threshold, the method 900 may further include determining whether the patterns present in the chromatographic data are similar to the patterns that the peak identification model was trained on (and/or to known patterns present in chromatographic data when a gas chromatogram device is not noisy). This determination may utilize and/or be based on one or more of (i) a distribution of the peak identification probabilities for the peaks that are mapped to a VOC (e.g., the max, mean, median, and/or standard deviation of the peak identification probabilities), and/or (ii) a morphology deep learning model (e.g., CNN, RNN, LSTM, GRU, transformer) trained to analyze the morphology of the input chromatographic data. For example, when the peak identification model outputs certainty levels that fail to satisfy the certainty threshold, the morphology model may analyze the chromatographic data and output indeterminate results indicating that the identification has failed, such that the matching results should not be trusted.

In certain embodiments, the trained peak identification model may be a deep learning model including one or more of: (i) a convolutional neural network (CNN), (ii) a recurrent neural network (RNN), (iii) a long short-term memory network, (iv) a gated recurrent unit (GRU), and/or (v) a transformer network.

In some embodiments, the post-processing algorithm may be at least one of: (i) a greedy optimization algorithm, (ii) an Integer Program algorithm, and/or (iii) a Naïve Bayes algorithm.

In certain embodiments, the example method 900 may further include applying the post-processing algorithm by: (a) determining, by the one or more processors, whether a chronology of the chromatographic data corresponds to a predetermined chronology of the set of reference VOCs. Further in these embodiments, the example method 900 may further include: (b) analyzing, by the one or more processors, the set of identified VOCs to determine whether any peaks from the chromatographic data are orphan peaks; and responsive to determining that (a) and (b) are satisfied, generating, by the one or more processors, the set of identified VOCs.

In some embodiments, the example method 900 may also include analyzing each peak in a derivative of the chromatographic data to determine whether a magnitude of any peak in the derivative exceeds a threshold value (block 912). Responsive to determining that the magnitude of a respective peak in the derivative does not exceed the threshold value, reducing, by the one or more processors, the magnitude of the respective peak in the derivative to zero (block 914). Further, the example method 900 may then generate the set of identified peaks without identifying the respective peak in the derivative (block 916). Even further, the set of identified peaks may be smoothed using a Gaussian-weighted moving average (block 918).

In certain embodiments, at least one peak in the set of identified peaks is a co-eluted peak that appears as part of another peak.

In certain embodiments, the method 900 further includes generating, by the one or more processors executing a simulation algorithm, a set of simulated chromatograms based on a set of reference chromatograms, and wherein the plurality of training chromatographic data is the set of simulated chromatograms.

In certain embodiments, the simulation algorithm comprises one or more of: (i) a Gaussian function, (ii) a modified Gaussian function, and/or (iii) an exponentially modified Gaussian function to generate the set of simulated chromatograms.

In certain embodiments, the chromatographic data is a one-dimensional (1D) chromatogram.

In certain embodiments, the method 900 further includes normalizing, by the one or more processors, the chromatographic data to a common value by dividing the chromatographic data by an area under the 1D chromatogram.

In certain embodiments, the chromatographic data includes data from a vapor space that includes at least one of: (i) exhaled breath, (ii) a wound, (iii) a skin surface, (iv) a sweat droplet, (v) an open cavity, (vi) a closed cavity, or (vii) a urinary catheter bag.

In certain embodiments, the method 900 further includes outputting, by the one or more processors, lists of matched diseases, which may include disease diagnosis, prognosis, severity, tracking, and/or other values associated with a disease or condition evaluation.

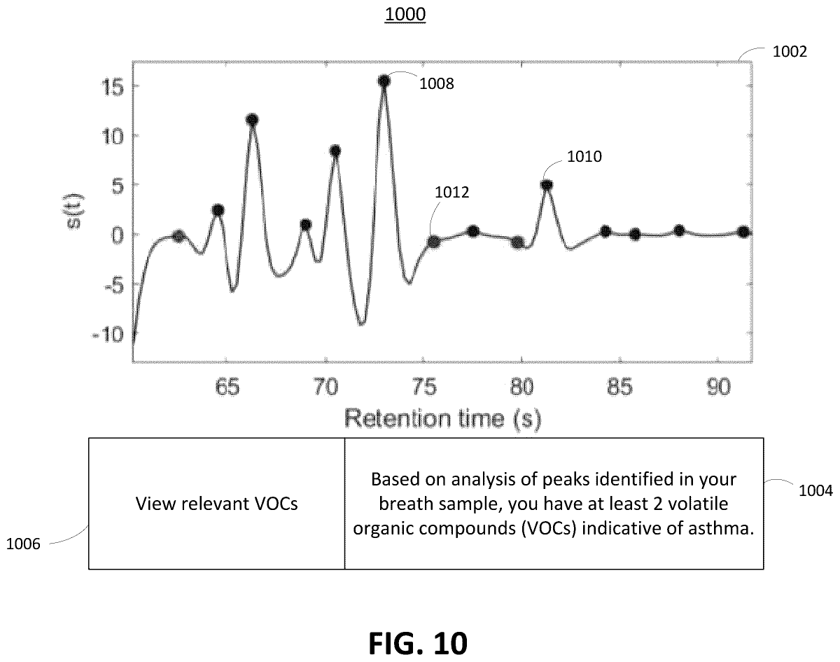

Moreover, the example method 900 may also include causing the set of identified VOCs to be displayed to the user (block 920). For example, FIG. 10 depicts an example graphical user interface display 1000 enabling a user to view identified gas chromatography peaks and a predicted diagnosis associated with VOCs corresponding to the identified/aligned peaks, in accordance with various aspects disclosed herein. In particular, as illustrated in FIG. 10, the user device (e.g., user device 108) may render a display that includes a graphical display portion 1002, a textual display portion 1004, and an interactive button display portion 1006.

The graphical display portion 1002 may include the user chromatographic data. represented as a gas chromatogram. The gas chromatogram may feature various peaks that have markings (e.g., bold dots 1008, 1010, 1012 of identified peaks) indicating which peaks may have been analyzed as part of the execution of the peak identification model and/or the post-processing algorithm. The graphical display portion 1002 may be interactive, such that a user may interact (e.g., click, tap, swipe, touch, gesture, etc.) with the graphical display portion 1002, and the example user interface display 1000 may display additional and/or otherwise different information than illustrated on the graphical display portion 1002. For example, a user may interact with the graphical display portion 1002 by tapping on an individual peak (e.g., 1008, 1010, 1012) of the gas chromatogram, and as a result, the processors may cause the example user interface display 1000 to display additional information concerning the VOC represented by the individual peak, such as the name of the VOC, implications of the VOC (e.g., potential medical implications of the presence of the VOC in the user's breath), and/or any other suitable data/information or combinations thereof.

Further, each of the peaks and/or any other suitable information/data/objects represented on the graphical display portion 1002 may be and/or otherwise include any suitable type of text, symbols, patterns, colors, and/or any other suitable visual indicia. For example, as illustrated in FIG. 10, the recognized peaks of the chromatographic data that may have been analyzed as part of the execution of the peak identification model and/or the post-processing algorithm may be marked with a bold dot or similar marking. The first and second identified peaks 1008, 1010 may be non-co-eluted peaks, and the third identified peak 1012 may be a co-eluted peak. Moreover, each object represented on the graphical display portion 1002 may be or include an image, video, and/or any other suitable visual display configuration.

Further, in certain embodiments, the graphical display portion 1002 may include indications that represent strength or other gradient values corresponding to the data displayed in the graphical display portion 1002. For example, the peak markings may include graphical relative strength indicators (e.g., colors, symbols, graphics, etc.) corresponding to a level of concern a user may have as a consequence of the presence of the VOC represented by the peak being present in the user's chromatographic data, numerical representations of the level of concern, textual strength indicators (e.g., “seek immediate medical attention”, “benign”, etc.), and/or any other suitable indicator types or combinations thereof.

The textual display portion 1004 may include a text-based message for a user that corresponds to the display within the graphical display portion 1002. For example, as illustrated in FIG. 10, the textual display portion 1004 includes text reading “Based on analysis of peaks identified in your breath sample, you have at least 2 volatile organic compounds (VOCs) indicative of asthma.” Thus, the text-based message within the textual display portion 1004 may enable a user to understand the context of the display within the graphical display portion 1002, and as a result, the user may make more informed decisions to seek medical attention/advice regarding a potential asthma diagnosis. In this manner, the textual display portion 1004 may enable the user to alleviate/mitigate risk associated with having asthma.

The interactive button display portion 1006 may generally enable a user to view additional information and/or initiate certain additional functionalities corresponding to the information presented in the example user interface display 1000. For example, a user may interact with the interactive button display portion 1006, and the processor may cause the example user interface display 1000 to display relevant VOCs that are present within the user's chromatographic data. These relevant VOCs may be or include the two VOCs indicated in the message of the textual display portion 1004 (e.g., represented by the first identified peak 1008 and the third identified peak 1012). Additionally, or alternatively, the interactive button display portion 1006 may cause the processor to initiate functionality outside of a display application or other application/module where the example user interface display 1000 is rendered in the event, for example, that a user may desire to contact a physician's office to discuss the results of their chromatographic data analysis and/or any other suitable additional functionality or combinations thereof. As another example, the user may interact with the interactive button display portion 1006, and the processor may access the Internet to retrieve and display information related to any VOCs that are flagged and/or otherwise determined as relevant within the user's chromatographic data.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but also deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing.” “calculating.” “determining,” “presenting.” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment,” “one aspect,” “an aspect,” or “an embodiment” means that a particular element, feature, structure, or characteristic described in connection with the embodiment is included in at least one embodiment/aspect. The appearances of the phrase “in one embodiment” or “in one aspect” in various places in the specification are not necessarily all referring to the same embodiment/aspect.

Some embodiments/aspects may be described using the expression “coupled” and “connected” along with their derivatives. For example, some embodiments/aspects may be described using the term “coupled” to indicate that two or more elements are in direct physical or electrical contact. The term “coupled,” however, may also mean that two or more elements are not in direct contact with each other, but yet still co-operate or interact with each other. The embodiments/aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments/aspects herein. This is done merely for convenience and to give a general sense of the description. This description, and the claims that follow, should be read to include one or at least one and the singular also includes the plural unless it is obvious that it is meant otherwise.

While the present invention has been described with reference to specific examples, which are intended to be illustrative only and not to be limiting of the invention, it will be apparent to those of ordinary skill in the art that changes, additions and/or deletions may be made to the disclosed embodiments/aspects without departing from the spirit and scope of the invention.

The foregoing description is given for clearness of understanding; and no unnecessary limitations should be understood therefrom, as modifications within the scope of the invention may be apparent to those having ordinary skill in the art.

What is claimed is:

1. A method for identifying gas chromatography peaks, the method comprising:
receiving, at one or more processors, chromatographic data of a user that includes data representing at least one volatile organic compound (VOC);
analyzing, by the one or more processors, the chromatographic data using a trained peak identification model to output a set of peak identification probabilities, wherein the trained peak identification model is trained using a plurality of training chromatographic data to output a plurality of training sets of peak identification probabilities;
generating, by the one or more processors, a set of identified peaks within the chromatographic data by applying a post-processing algorithm to the set of peak identification probabilities; and
causing, by the one or more processors, the set of identified peaks to be displayed to the user.

2. The method of claim 1, wherein at least one peak in the set of identified peaks is a co-eluted peak that appears as part of another peak.

3. The method of claim 1, further comprising:
generating, by the one or more processors executing a simulation algorithm, a set of simulated chromatograms based on a set of reference chromatograms, and
wherein the plurality of training chromatographic data is the set of simulated chromatograms.

4. The method of claim 3, wherein the simulation algorithm comprises one or more of:
(i) a Gaussian function, (ii) a modified Gaussian function, or (iii) an exponentially modified Gaussian function to generate the set of simulated chromatograms.

5. The method of claim 1, wherein the chromatographic data is a one-dimensional (1D) chromatogram.

6. The method of claim 5, further comprising:
normalizing, by the one or more processors, the chromatographic data to a common value by dividing the chromatographic data by an area under the 1D chromatogram.

7. The method of claim 1, wherein the trained peak identification model is a deep learning model including one or more of: (i) a convolutional neural network (CNN), (ii) a recurrent neural network (RNN), (iii) a long short-term memory network, (iv) a gated recurrent unit (GRU), or (v) a transformer network.

8. The method of claim 1, wherein applying the post-processing algorithm further comprises:
analyzing, by the one or more processors, each peak in a derivative of the chromatographic data to determine whether a magnitude of any peak in the derivative exceeds a threshold value;
responsive to determining that the magnitude of a respective peak in the derivative does not exceed the threshold value, reducing, by the one or more processors, the magnitude of the respective peak in the derivative to zero; and
generating, by the one or more processors, the set of identified peaks without identifying the respective peak in the derivative.

9. The method of claim 1, further comprising:
smoothing, by the one or more processors, the set of identified peaks using a Gaussian-weighted moving average.

10. The method of claim 1, wherein the chromatographic data comprises data from a vapor space that includes at least one of: (i) exhaled breath, (ii) a wound, (iii) a skin surface, (iv) a sweat droplet, (v) an open cavity, (vi) a closed cavity, or (vii) a urinary catheter bag.

11. The method of claim 1, further comprising:
outputting, by the one or more processors, lists of matched diseases, which may include disease diagnosis, prognosis, severity, tracking, and/or other values associated with a disease or condition evaluation.

12. A system for identifying gas chromatography peaks, the system comprising:
a memory storing a set of computer-readable instructions; and
one or more processors interfacing with the memory, and configured to execute the set of computer-readable instructions to cause the one or more processors to:
receive chromatographic data of a user that includes data representing at least one volatile organic compound (VOC),
analyze the chromatographic data using a trained peak identification model to output a set of peak identification probabilities, wherein the trained peak identification model is trained using a plurality of training chromatographic data to output a plurality of training sets of peak identification probabilities,
generate a set of identified peaks within the chromatographic data by applying a post-processing algorithm to the set of peak identification probabilities, and
cause the set of identified peaks to be displayed to the user.

13. The system of claim 12, wherein at least one peak in the set of identified peaks is a co-eluted peak that appears as part of another peak.

14. The system of claim 12, wherein the computer-readable instructions, when executed by the one or more processors, cause the one or more processors to:
generate, by executing a simulation algorithm, a set of simulated chromatograms based on a set of reference chromatograms, and
wherein the plurality of training chromatographic data is the set of simulated chromatograms.

15. The system of claim 14, wherein the simulation algorithm comprises one or more of:
(i) a Gaussian function, (ii) a modified Gaussian function, or (iii) an exponentially modified Gaussian function to generate the set of simulated chromatograms.

16. The system of claim 12, wherein the chromatographic data is a one-dimensional (1D) chromatogram.

17. The system of claim 16, wherein the computer-readable instructions, when executed by the one or more processors, cause the one or more processors to:
normalize the chromatographic data to a common value by dividing the chromatographic data by an area under the 1D chromatogram.

18. The system of claim 12, wherein the trained peak identification model is a deep learning model including one or more of: (i) a convolutional neural network (CNN), (ii) a recurrent neural network (NN), (iii) a long short-term memory network, (iv) a gated recurrent unit (GRU), or (v) a transformer network.

19. The system of claim 12, wherein the computer-readable instructions, when executed by the one or more processors, cause the one or more processors to apply the post-processing algorithm by:
analyzing each peak in a derivative of the chromatographic data to determine whether a magnitude of any peak in the derivative exceeds a threshold value;
responsive to determining that the magnitude of a respective peak in the derivative does not exceed the threshold value, reducing the magnitude of the respective peak in the derivative to zero; and
generating the set of identified peaks without identifying the respective peak in the derivative.

20. A non-transitory computer-readable storage medium having stored thereon a set of instructions, executable by at least one processor, for identifying gas chromatography peaks, the instructions comprising:
instructions for receiving chromatographic data of a user that includes data representing at least one volatile organic compound (VOC);
instructions for analyzing the chromatographic data using a trained peak identification model to output a set of peak identification probabilities, wherein the trained peak identification model is trained using a plurality of training chromatographic data to output a plurality of training sets of peak identification probabilities;
instructions for generating a set of identified peaks within the chromatographic data by applying a post-processing algorithm to the set of peak identification probabilities; and
instructions for causing the set of identified peaks to be displayed to the user.
